(19) United States
(12) Patent Application Publication
(10) Pub. No.: US 2015/0156079 A1
(43) Pub. Date: Jun. 4, 2015

(54) Methods and Apparatus to Dynamically Provide Network Policies

(71) Applicant: AT&T Intellectual Property I, L.P., Atlanta, GA (US)

(72) Inventors: Michael J. Satterlee, Clifton Park, NY (US); Richard Bowers, Westfield, NJ (US); Jamil Cheikhali, Tampa, FL (US); Dustin Grant, Fall City, WA (US); Sandeep Gupta, Milpitas, CA (US)

(73) Assignee: AT&T Intellectual Property I, L.P., Atlanta, GA (US)

(21) Appl. No.: 14/096,999

(22) Filed: Dec. 4, 2013

(51) Int. Cl. H04L 12/24

(52) U.S. Cl. CPC H04L 41/50

(57) ABSTRACT

Methods and apparatus to dynamically provide network policies are disclosed. An example method includes determining a context associated with an attempt to access, by a user via a computing device, a network; selecting a network policy based on the determined context; and programming, in response to the attempt to access the network, a dynamically programmable network element to enforce the network policy.

### BACKGROUND

Network policy management for enterprise networks (e.g., a network of a company or other type of entity) involves setting and implementing policies that determine how users and/or groups of users associated with a corresponding enterprise are able to utilize the enterprise network and/or network devices accessible via the enterprise network. The network policies include rules and/or settings that define, for example, bandwidth restrictions and/or guarantees, prioritization, access control, closed user group assignments, etc. Network policy management systems enforce network policies by configuring network elements (e.g., access points, edge routers, etc.) according to the rules and/or settings of the network policies. The pre-configured network elements operate autonomously to statically enforce the network policies. That is, the network elements of such systems are statically configured with the network policies prior to users accessing the network via the network elements.

### BRIEF DESCRIPTION OF THE DRAWINGS

FIG. 1 is a block diagram of a first example communication environment including an example network policy provider (NPP) constructed in accordance with teachings of this disclosure.

FIG. 2 is a block diagram of an example implementation of the example policy manager of FIG. 1.

FIG. 3 is a block diagram of an example implementation of the example identifier of FIG. 1.

FIG. 4 is a block diagram of an example implementation of the example network element programmer of FIG. 1.

FIG. 5 is a block diagram of an example implementation of the example network usage visualizer of FIG. 1.

FIGS. 6A and 6B are a flow diagram representative of example machine readable instructions which may be executed to implement the example NPP represented in FIGS. 1-5.

FIG. 7 is a block diagram of an example processor platform capable of executing the example instructions of FIGS. 6A and 6B to implement the example NPP of FIGS. 1-5.

### DETAILED DESCRIPTION

This disclosure relates generally to communication networks, and, more particularly, to methods and apparatus to dynamically provide network policies. Network policy management for enterprise networks (e.g., a network of a company or other type of entity) involves setting and implementing policies that determine how users and/or groups of users associated with a corresponding enterprise are able to utilize the enterprise network and/or network devices accessible via the enterprise network. The network policies include rules and/or settings that define, for example, bandwidth restrictions and/or guarantees, prioritization, access control, closed user group assignments, etc. Network policy management systems enforce network policies by configuring network elements (e.g., access points, edge routers, etc.) according to the rules and/or settings of the network policies. The pre-configured network elements operate autonomously to statically enforce the network policies. That is, the network elements of such systems are statically configured with the network policies prior to users accessing the network via the network elements. Because the network policies are set statically, these network policy management systems do not dynamically enforce a network policy based on contextual, real-time information associated with individual accesses of the network. Accordingly, network elements interacting with such network policy management systems rigidly, fixedly enforce previously stored policy definitions regardless of, for example, an identity of the user accessing the network and/or which device or device type is being used to access the network.

Example methods, apparatus, and/or articles of manufacture disclosed herein dynamically provide network policy enforcement in response to a user accessing a network (e.g., a proprietary network of a company that provides access to resources of the network to, for example, employees). Examples disclosed herein obtain information regarding the context and/or circumstances under which the network is being accessed. Further, examples disclosed herein dynamically (e.g., at a time substantially similar to (e.g., within a threshold of) the access of the network) select a network policy based on the obtained context and/or circumstance(s) and dynamically (e.g., at a time substantially similar to the access of the network) program a network element to enforce the selected network policy. Example circumstances include an identity of a particular user that is accessing the network, an identity of a particular computing device (e.g., a device having an identifier assigned to the particular user), a type of computing device (e.g., a personal computer, a tablet, a smart phone, a laptop, etc.) being used to access the network, a resource being accessed, and a location from which the network is being accessed. The collection of circumstances defines a context for a network access session and/or a communication session. Examples disclosed herein use any one of the circumstances associated with the access of the network and/or a combination of the circumstances associated with the access of the network to, in real-time or substantially real-time, select the appropriate network policy. Examples disclosed herein dynamically (e.g., at a time substantially similar to the access of the network and/or the attempt to access the network) program particular network element(s) (e.g., router(s) and/or switch(es)) that are facilitating communication with the network to enforce the selected network policy (e.g., during a session corresponding to the detected access of the network). That is, examples disclosed herein dynamically select and enforce a selected one of a plurality of network policies based on the context of a network access (e.g., based on one or more circumstances such as a user identity, a device identity, a type of device, a resource being accessed, and/or a location from which the user is accessing the network). Thus, rather than the network elements being statically configured with network policies prior to the user initiating a session with the network and the network elements rigidly enforcing the pre-configured network policy irrespective of context as in known systems, examples disclosed herein program network elements utilized to access the network under certain context (e.g., as defined by one or more circumstances) with a network policy designated for use with the certain context present at a time of access of the network by the user. Accordingly, examples disclosed herein enable, for example, one or more network policies associated with (e.g., assigned to) a particular user to follow the particular user around and to be enforced on the particular user regardless of where or how the user accesses the network (e.g., an enterprise network).

Examples disclosed herein utilize one or more Software Defined Networking (SDN) technologies to program the network elements at a time of a user accessing and/or attempting to access the network. In such instances, examples disclosed herein utilize network elements enabled with SDN applications such as, for example, One Platform Kit (onePK) or Openflow®. Such SDN capability enables examples disclosed herein to program a corresponding network element dynamically, in real-time to enforce a certain network policy for a particular use in response to the user attaching to the enterprise network via the SDN-enabled network element.

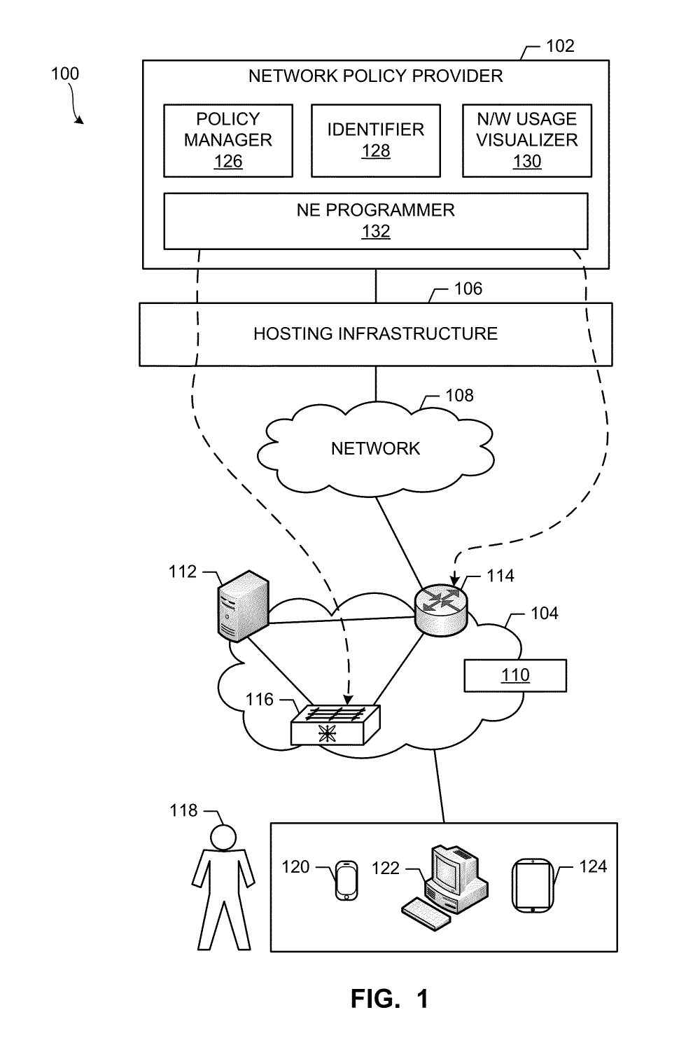

FIG. 1 illustrates an example communication environment 100 including an example network policy provider (NPP) 102 constructed in accordance with teachings of this disclosure. In the illustrated example of FIG. 1, the NPP 102 is hosted on one or more servers operated by a service provider such as, for example, AT&T®. However, any suitable entity may implement and/or provide the example NPP 102 of FIG. 1. In the example of FIG. 1, the NPP 102 provides dynamic, per-user network policy management to an enterprise having an enterprise network 104 such as, for example, a company that subscribes to services provided by AT&T®. The example NPP 102 of FIG. 1 communicates with the enterprise network 104 via a hosting infrastructure 106 managed by the service provider implementing the NPP 102 and a network 108. In the illustrated example of FIG. 1, the hosting infrastructure 106 includes one or more databases, firewalls, servers, routers, access networks and/or other devices and/or applications that facilitate and/or secure communication between the example NPP 102 of FIG. 1 and other computing devices. In the illustrated example of FIG. 1, the network 108 is implemented via a virtual private network (VPN) 108 executing in a public network such as, for example, the Internet, a local area network (LAN), a wide area network (WAN), and/or any other suitable network. In some examples, the network 108 is implemented by AT&T Virtual Private Network (AVPN), which is a network-based Internet Protocol (IP) VPN application that is enabled by Multiprotocol Label Switching (MPLS). However, the example NPP 102 of FIG. 1 may communicate with the enterprise network 104 and/or components thereof via any past, present or future protocol(s), standard(s), network(s), transmission medium(s), etc.

The example enterprise network 104 of FIG. 1 provides one or more services to a plurality of users that are authorized to access the enterprise network 104. Access to the example enterprise network 104 of FIG. 1 enables the users to communicate with one or more resources 110 of the enterprise network 104. Example resources 110 of the enterprise network 104 of FIG. 1 include email servers, databases, file systems, data sharing applications, intra-company communication applications, sources of advanced computing power, etc. In some instances, the users access the enterprise network 104 from a location (e.g., a building) at which the enterprise is based. In some instances, the users access the enterprise network 104 remotely (e.g., from a location other than the building of the enterprise). When accessing the enterprise network 104 remotely, the user may gain access via, for example, the network 108 and/or a VPN implemented over the network 108.

To authenticate users attempting to access the enterprise network 104, the example enterprise network 104 of FIG. 1 includes an authentication device (e.g., a RADIUS server) 112. The example authentication device 112 of FIG. 1 is queried with, for example, a user name, a password, a certificate, etc. provided by users attempting to access a resource of the enterprise network 104. The example authentication device 112 of FIG. 1 determines whether the corresponding users are authorized users (e.g., clients, employees, contractors, members of the enterprise, etc.) associated with the enterprise network 104 and/or otherwise authorized to access the enterprise network 104. Based on the determinations made by the example authentication device 112 of FIG. 1, users are granted or denied access to the enterprise network 104.

In the illustrated example of FIG. 1, the enterprise network 104 includes at least one router 114 and at least one switch 116. The example router 114 of FIG. 1 provides routing, forwarding, and/or other network layer functionality to facilitate communication between, for example, devices within the enterprise network 104, and/or devices of the enterprise network 104 and external computing devices. The example router 114 of FIG. 1 is implemented by an SDN-enabled router capable of implementing one or more SDN techniques, applications, and/or technologies. That is, the example router 114 of FIG. 1 can be dynamically programmed in real-time or near real-time via one or more software configurations and/or adjustments to adhere to one or more network policies. In contrast, previous routers incapable of implemented SDN techniques and/or technologies and/or were statically configured devices that could not be reprogrammed in real-time or near real-time. In some examples, the router 114 of FIG. 1 is implemented by a Cisco® Integrated Services Router having a One Platform Kit (onePK) installed thereon. In some examples, the router 114 of FIG. 1 is implemented by a router implementing the OpenFlow standard to enable real-time or near real-time programming of the router 114.

The example switch 116 of FIG. 1 is implemented by an SDN-enabled switch capable of implementing one or more SDN techniques, applications, and/or technologies. The example switch 116 of FIG. 1 can be dynamically programmed in real-time or near real-time via one or more software configurations and/or adjustments to adhere to one or more network policies. In some examples, the switch 116 of FIG. 1 is implemented by a Cisco Catalyst 3000® (CAT 3k) switch having a One Platform Kit (onePK) and/or one or more OpenFlow applications installed thereon.

In the illustrated example of FIG. 1, the NPP 102 dynamically programs a network policy into the example router 114 and/or the example switch 116 at a time of (e.g., in response to) a user 118 accessing (e.g., attaching to, authenticating, logging in, etc.) the enterprise network 104. Which one(s) of the example router 114 and the example switch 116 are dynamically programmed depends on, for example, a type of the enterprise network 104 and/or the policy to be enforced. For example, when the example enterprise network 104 of FIG. 1 corresponds to a managed local area network (LAN)/WiFi customer, the example NPP 102 of FIG. 1 programs the example router 114 and the example switch 116 according to the appropriate network policy. Additionally, when the example enterprise network 104 of FIG. 1 corresponds to a managed router customer, the example NPP 102 programs the example router 114 but not the example switch 116 (e.g., due to restrictions on the NPP 102 communicating with the switch 116). While the NPP 102 is described below as programming the example router 114 and/or the example switch 116 of FIG. 1, the example NPP 102 of FIG. 1 may program additional or alternative network elements of the example enterprise network 104, the example network 108, the example hosting infrastructure 106, and/or any other network element(s) being used to facilitate communication involving the user 118.

In the illustrated example of FIG. 1, the user 118 is associated with first 120, second 122 and third 124 computing devices capable of accessing the example enterprise network 104. In the illustrated example, the first computing device 120 is a smart phone, the second computing device 122 is a personal computer (e.g., a desktop computer or a laptop computer), and the third computing device 124 is a tablet (e.g., an iPAD®). The mobility of at least the first and third computing devices 120, 124 enables the user 118 to access the example enterprise network 104 from any location at which communication with, for example, the network 108 is available. For example, the user 118 of FIG. 1 may use the smart phone 120 to request access to an email server of the enterprise network 104 while at an airport, while commuting, and/or from a residence of the user 118. In such instances, the example smart phone 120 communicates with, for example, the resources 110 of the enterprise network 104 via the example router 114 and, for example, a wide-area network (WAN) portion of the network 108. In some examples, the user 118 requests access to the enterprise network 104 via the personal computer 122, which may be a desktop computing intended to be used at a same location of a building occupied by the enterprise (e.g., an owned or leased building). In such instances, the example personal computer 122 communicates with, for example, the resources 110 of the enterprise network 104 via the example switch 116 an a local area network (LAN) portion of the network 108. The example user 118 may utilize one or more additional or alternative computing devices to exchange data with, for example, the resources 110 of the enterprise network 104 from one or more additional or alternative locations.

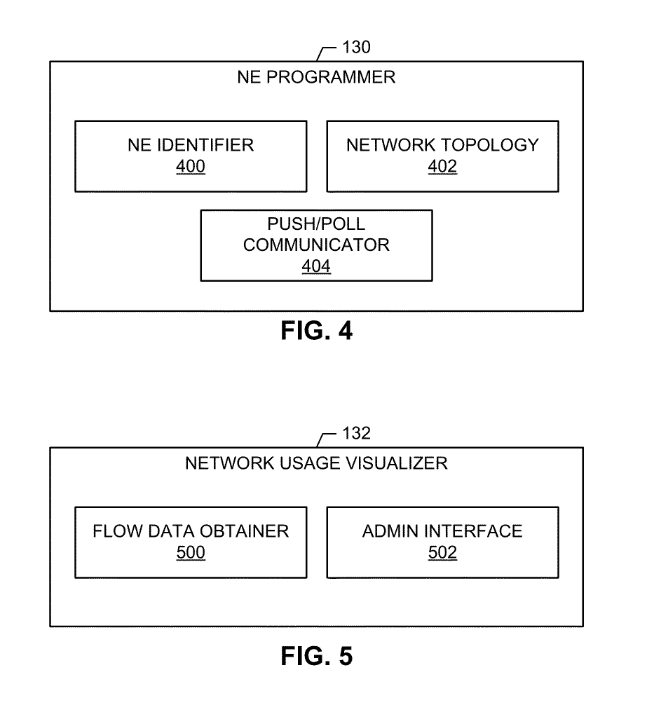

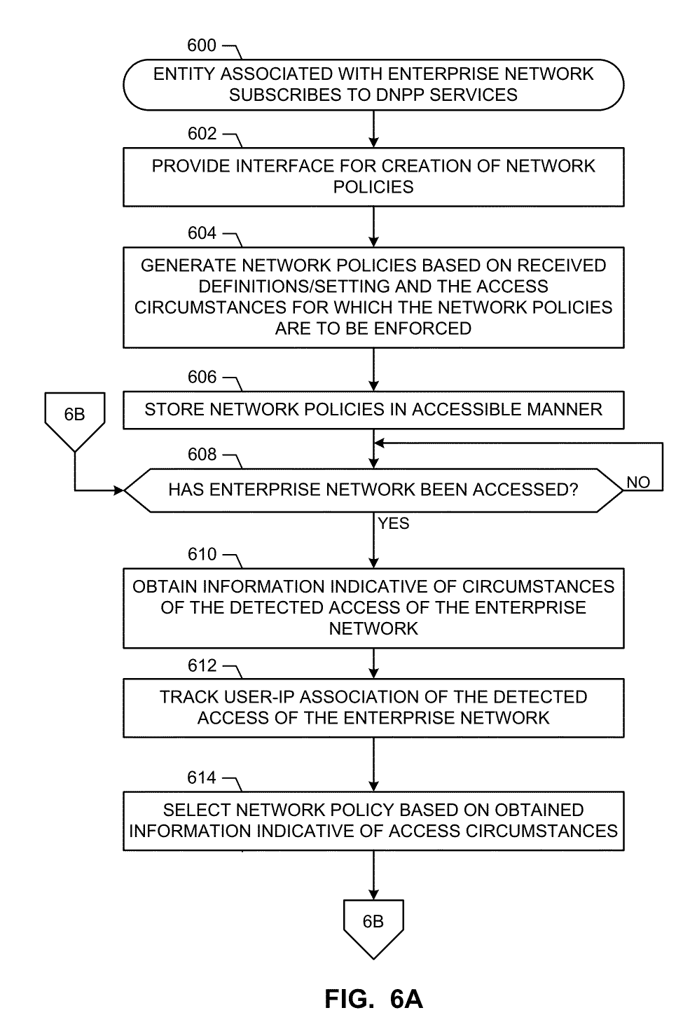

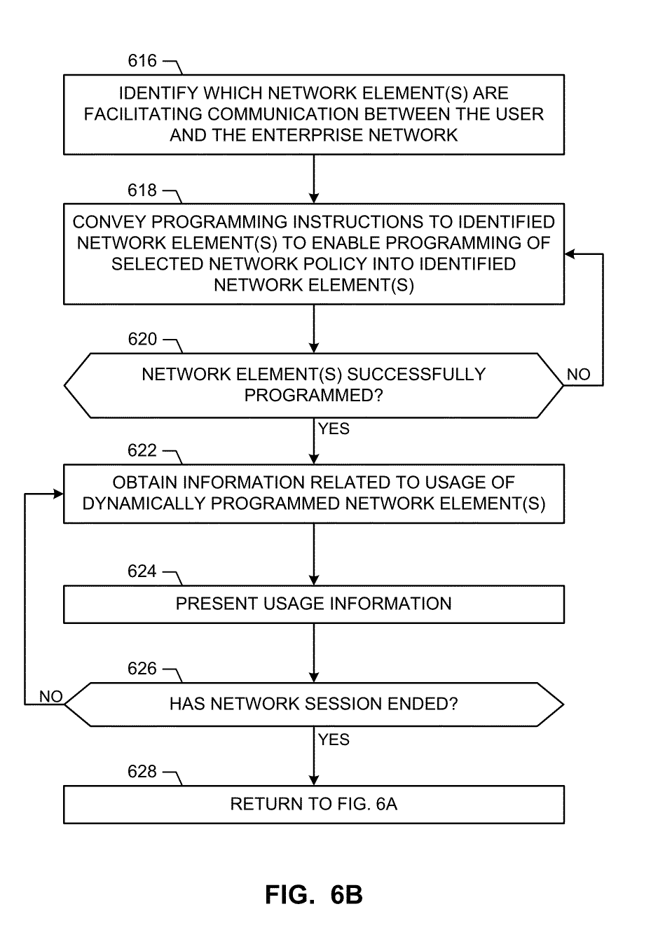

The example NPP 102 of FIG. 1 of FIG. 1 responds to the example user 118 accessing (e.g., logging on, entering credentials, being authenticated, etc.) the example enterprise network 104 by dynamically enforcing a particular network policy while the user 118 interacts with the enterprise network 104. The example NPP 102 of FIG. 1 enables dynamic enforcement of network policies based on, for example, an identity of the user 118 accessing the enterprise network 104, an identity of the device being used to access the enterprise network 104, an identity of the resource being accessed, and/or a location from which the user 118 accesses the enterprise network 104. To do so, the example NPP 102 of FIG. 1 includes a policy manager 126, an identifier 128, a network usage tracker 130, and a network element (NE) programmer 132. As described in detail below in connection with FIG. 3, the example policy manager 126 of FIG. 1 enables creation of one or more network policies for the user 118, the user device, the location, and/or the network resource, and makes the one or more network policies available for selection based on, for example, the circumstances defining the context associated with the access of the enterprise network 104. As described in detail below in connection with FIG. 4, the example identifier 128 of FIG. 1 collects information associated with an access of the enterprise network 104 (e.g., an identity of a user accessing the enterprise network 104, an identity of a computing device being used to access the enterprise network 104, an identity of a resource being accessed, and/or a location from which the enterprise network 104 is being accessed) and selects one or more network policies managed by the example policy manager 126 of FIGS. 1 and/or 3 for enforcement during the corresponding session. As described in detail below in connection with FIG. 5, the example NE programmer 132 of FIG. 1 obtains the selected network policy to be enforced and programs the network element(s) currently being used by the identified user to communicate with the enterprise network 104. As described in detail below in connection with FIG. 6, the example network usage visualizer 130 of FIG. 1 collects data regarding usage associated with the detected access of the enterprise network 104 and/or other accesses, and communicates information related to the collected data to, for example, an administrator of the example NPP 102 of FIG. 1.

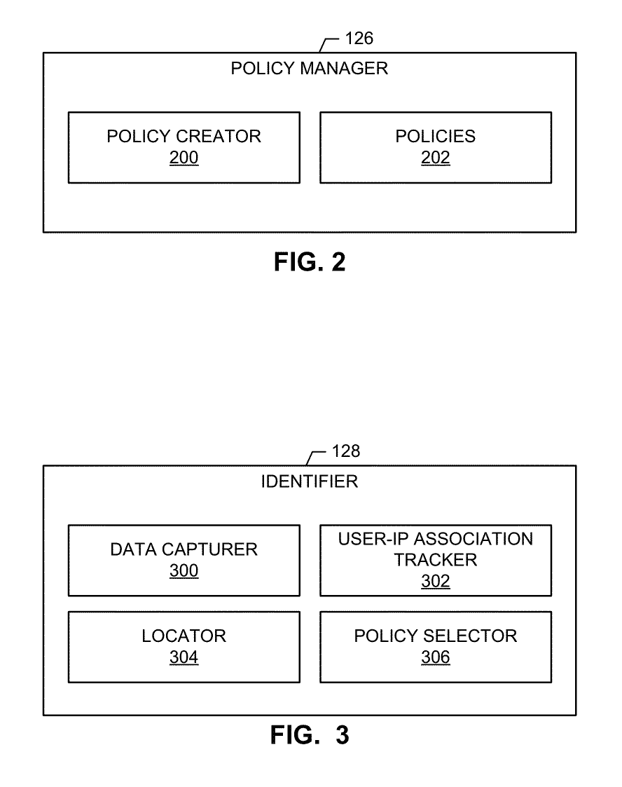

FIG. 2 illustrates an example implementation of the policy manager 126 of FIG. 1. The example policy manager 126 of FIG. 2 includes a policy creator 200 to enable generation of one or more user-specific network policies that govern how a corresponding user interacts with the example enterprise network 104 of FIG. 1 during a specific network session given a particular set of circumstances associated with that network session. The example policy manager 126 of FIG. 2 stores and/or manages the storage of the policies 202 and makes the policies available for use by, for example, the NE programmer 132 of FIGS. 1 and/or 4.

In the illustrated example of FIG. 2, the policy creator 200 implements a user interface accessible to administrators of the example NPP 102. The user interface provided by the example policy creator 200 of FIG. 2 provides the administrators with tools to define rules, settings, and/or terms of the network policies by, for example, selecting from a plurality of options and/or entering information into one or more data entry fields. Further, the example policy creator 200 of FIG. 2 provides the administrators with tools to define circumstances for which one or more network policies are to be selected for enforcement. For example, the tools enable the administrator to designate a certain network policy for enforcement when a particular user accesses the enterprise network 104, designate a certain network policy for enforcement when a particular computing device is used to access the enterprise network 104, designate a certain network policy for enforcement when a particular type of computing device is used to access the enterprise network 104, designate a certain policy for accessing from outside the enterprise network 104, designate a certain policy when a certain network resource is accessed, etc. In some examples, each policy created via the example policy creator 200 is represented and/or interacted with via an individual widget application facilitated by the example policy creator 200. Example aspects and/or capabilities of the policies created via the example policy creator 200 of FIG. 2 include user-specific rules, location-specific rules, user role-specific rules, user group-specific rules, device-specific rules, device type-specific rules, traffic prioritization for specific users, categorization of application traffic with different class of service (CoS) values, geography based limitations of network access, geography independent network access from enterprise sites, ability to deny access to particular applications and/or resources of the enterprise network 104, restrictions based on an amount of data flowing towards a user, restrictions based on an amount of data flowing towards a user from specific applications and/or resources of the enterprise network 104, threat detection such as alarms or notifications of abnormal activity on a per user basis (which may be supplemented with contextual information such as device type, device identification, user identification, etc.), an ability to prevent threats by, for example, dropping the user access in response to a qualifying threat detection event, an ability to mimic or duplicate traffic flow characteristics of another network element, etc. Additional or alternative aspects and/or features of network policies may be defined and/or set via the example policy creator 200.

As disclosed herein, each of the network policies can be designated for use in response to identifying, for example, a particular user accessing the enterprise network 104, a particular computing device being used to access the enterprise network 104, a particular one of the resources 110 being accessed, and/or a particular location from which the enterprise network 104 is being accessed. That is, each of the policies 202 is designed to be enforced when a particular context defined by a circumstance and/or set of circumstances are associated with the current network session. For example, a first one of the policies 202 is designated to be enforced (e.g., programmed into a network element facilitating communication with the enterprise network 104) when the user 118 is identified as the person accessing the enterprise network 104, regardless of where the user 118 is accessing the enterprise network 104 from, regardless of which network resource(s) are being accessed, and regardless of which of the computing devices 120-124 is being used to access the enterprise network 104. In some examples, a second one of the policies 202 is designated to be enforced when the user 118 is identified as the person accessing the enterprise 104 and the location from which the enterprise network 104 is being accessed is identified as a particular location (e.g., a site within a LAN of the enterprise) or type of location (e.g., away from the site, outside of the United States, etc.). In some examples, a third one of the policies 202 is designated to be enforced when the user 118 is attempting to access particular one(s) of the resources 110. Additional or alternative combinations of circumstances can be used to designate which one of the policies 202 is to be enforced for a particular network session. In some examples, the one or more of the network policies 202 of FIG. 2 are bound to the user 118 and are enforced against the user 118 wherever and/or however the user 118 accesses the enterprise network 104.

When the administrators have defined a network policy to be enforced with respect to, for example, the user 118 of FIG. 1, the defined network policy is stored in the policies 202 in association with (e.g., in a data structure entry tied to) identification information associated with the user 118. The identification information stored in association with the entries of the policies 202 may be obtained from the example identifier 128 of FIGS. 1 and/or 3. In some examples, the identification information stored in association with the entries of the policies 202 include 5-tuple data (e.g., source IP address, destination IP address, source port number, destination port number and the protocol in use) for use in the corresponding network policies.

FIG. 3 illustrates an example implementation of the example identifier 128 of FIG. 1. The example identifier 128 of FIG. 3 includes a data capturer 300, a user-IP association tracker 302, a locator 304, and a policy selector 306. The example data capturer 300 collects information indicative of an identity of a user currently interacting with (e.g., exchanging data with, requesting data from, sending data to, and/or attempting to access) the example enterprise network 104 of FIG. 1. In the illustrated example of FIG. 3, the data capturer 300 interfaces with the example authentication device 112 to obtain an identity of, for example, the user 118. In particular, when a network session has been initiated with, for example, one or more of the resources 110 of the enterprise network 104, the example data capturer obtains data that was submitted to the authentication device 112 in connection with the attempt to initiate the network session. For example, the user 118 of FIG. 1 has a user name that is associated with identifying information (e.g., a full name, a social security number, an employee identification number, a role in the company, etc.) indicative of an identity of the user 118. The authentication device 112 of FIG. 1 may supply the example data capturer 300 with the identifying information to inform the identifier 128 of the identity of the user 118. Further, the example data capturer 300 of FIG. 3 obtains information regarding which of the computing devices 120-124 is being utilized by the user 118 to access the enterprise network 104 in the corresponding session. In particular, the example computing devices 120-124 may be assigned device identifying information that is tracked by the enterprise implementing the example enterprise network 104. Having the device identifying information also provides device-type identifying information to the example data capturer 300 of FIG. 3. Thus, the example data capturer of FIG. 3 obtains an identity of the user 118, an identity of the computing device being utilized by the user 118 to access the enterprise network 104, the type of the computing device being utilized by the user 118 to access the enterprise network 104, and/or any other information indicative of the context of the current attempt to access of the enterprise network 104 by the user 118.

The example user-IP association tracker 302 of FIG. 3 obtains and tracks network address information that associates the identified user 118 with a network address currently assigned to the computing device (e.g., the first, second or third computing devices 120-124 of FIG. 1) being utilized to attempt to access the enterprise network 104. For example, the example user-IP association tracker 302 ties a detected IP address to the user 118 for the duration of the network session. In the illustrated example of FIG. 3, the network address information to which the user identity is tied is obtained from the authentication device 112 of FIG. 1. When the user 118 logs onto the enterprise network 104, the authentication device 112 receives a request from a particular network address. The example user-IP association tracker 302 of FIG. 3 obtains the network address from the authentication device 112 and tracks that network address as associated with the identified user 118 for the instant network session.

The example locator 304 of FIG. 3 uses the obtained network address information associated with the current access of the enterprise network 104 to determine a location (e.g., a geographic location) from which the user 118 is attempting to access the enterprise network 104. In some examples, the locator 304 queries a database and/or other source of location information associated with different network addresses and/or groups of network addresses (e.g., IP address groupings) to determine the corresponding physical location.

The example policy selector 306 of FIG. 3 dynamically selects one or more of the network policies 202 managed by the example policy manager 126 of FIGS. 1 and/or 2 to be enforced during the current network session for which the information discussed above was obtained by the example data capturer 300, the example locator 304 and/or any other suitable data source. In the illustrated example of FIG. 3, the policy selector 306 uses one or more of the data collected by the example identifier 128 (and/or any other suitable data source) to query the example policies 202. As described above, the example policies 202 maintain designations indicative of which one(s) of the policies 202 are to be enforced given a particular context as indicated by a circumstance and/or set of circumstances associated with an attempt by the user 118 to access the enterprise network 104. Therefore, the data obtained by the example identifier 128 of FIG. 3 enables a determination of which of the policies 202 is to be dynamically enforced for the current network session. Although many examples discussed herein refer to selecting one or more network policies in response to an attempted access, policies may additionally or alternatively be set at other times. For example, if a changed circumstance is detected after a session is initiated, a new policy may be invoked and/or an existing policy may be terminated.

FIG. 4 illustrates an example implementation of the example NE programmer 130 of FIG. 1. In the illustrated example of FIG. 4, the NE programmer 130 is implemented by an SDN device capable of interfacing with SDN-capable network elements. In other words, the example NE programmer 130 is capable of dynamically (e.g., in real-time) programming network elements that have one or more programmable function(s), application(s), component(s), etc. In the illustrated example, the NE programmer 130 leverages OnePK APIs and/or Openflow applications associated with the network elements to dynamically program the corresponding network elements. Such applications provide computing devices interacting with the programmable network elements to communicate instructions, parameters, setting information, etc. in a format known to the network element and usable by the network element to alter a manner in which network traffic is handled for particular session(s), port(s), etc. Therefore, the example NE programmer 130 is aware of the type of information, data, instructions, parameters, etc. that can be used to instruct, program or cause the programmable network element to handle network traffic. Further, the example NE programmer 130 is aware of the manner in which the programming instructions, settings, parameters, etc. are to be passed or communicated to the programmable network elements such that the network elements can facilitate the corresponding programming.

The example NE programmer 130 of FIG. 4 receives the network policy selected by, for example, the policy selector 306 of FIG. 3. As described above, the selected network policy is to be enforced with respect to the identified user 118 during a current network session with the example enterprise network 104. That is, the example NE programmer 130 of FIG. 4 is made aware of the network policy that is to govern the current interactions of the user 118 with, for example, the resources 110 of the example enterprise network 104. The example NE programmer 130 of FIG. 4 includes an NE identifier 400 to determine which network element(s) are to be dynamically programmed with the selected network policy. As described above, the example user 118 exchanges information with the example authentication device 110 of FIG. 1 from a point of access when access to the enterprise network 104 is desired. Because the authentication device 110 has communicated with the computing device 120-124 being utilized to access the enterprise network 104, the example authentication device 110 of FIG. 1 includes information related to which network element(s) (e.g., router(s), switch(es), access point(s), etc.) are facilitating the communications between the example user 118 and the enterprise network 104. Further, the example NE programmer 130 of FIG. 4 includes a network topology 402 indicative of relationships between different network elements involved in facilitating communication with the example enterprise network 104. For example, the network topology 402 of FIG. 4 includes data representative of locations associated with the enterprise network 104. The example NE programmer 130 of FIG. 4 utilizes the network element identifying information obtained via the authentication device 110 of FIG. 1 and/or the information of the network topology 402 to determine which network element(s) are currently involved in enabling the user 118 to communicate with the example enterprise network 104. For example, the NE identifier 400 of FIG. 4 determines that the example router 114 and/or the example switch 116 are to be programmed to implement the selected (e.g., user-specific, device specific, device type-specific, etc.) network policy. The determination of which network element(s) are to be programmed to implement the selected network policy may additionally or alternatively include consideration of a type of the enterprise network 104. For example, when the enterprise network 104 corresponds to a managed router customer (e.g., where the provider of the example NPP 102 has access to the example router 114 but not the example switch 116), the NE identifier 400 identifies the example router 114 as the network element to be dynamically programmed. In some examples, when the enterprise network 104 corresponds to a managed LAN/Wifi customer (e.g., where the provider of the example NPP 102 has access to the example router 114 and the example switch 116), the NE identifier 400 identifies the example router 114 and/or the example switch 116 as the network element(s) to be dynamically programmed. In such instances, the example router 114 is identified as the network element to be dynamically programmed when the user 118 is accessing the enterprise network 104 from outside the LAN. Alternatively, the example NE identifier 400 determines that the example switch 116 is to be dynamically programmed when the user 118 is accessing the enterprise network 104 from within the LAN. In some examples, the NE identifier 400 determines that each network element involved in the current network session that is capable of being dynamically programmed is to be dynamically programmed to implement the selected network policy. Additional or alternative approaches to determine which network element(s) are to be dynamically programmed with the selected network policy are possible.

The example NE programmer of FIG. 4 includes a push/poll communicator 404 to interface with (e.g., communicate with) the network elements selected for the dynamic programming disclosed herein. In some examples, the push/poll communicator 404 of FIG. 4 pushes programming instructions, parameters, settings and/or other data to the network elements to cause the programmable network elements to implement the selected network policies (e.g., by programming one or more network traffic handling devices and/or applications). In the illustrated example of FIG. 4, the push/poll communicator 404 pushes programming instructions to the appropriate network elements (e.g., as determined by the example NE identifier 400). The programming instructions communicated by the example push/poll communicator 404 of FIG. 4 include information indicative of the parameters, terms, rules, settings, etc. of the selected network policy such that the programmable network element(s) dynamically govern the communications between the user 118 and the enterprise network 104 according to the selected network policy. As described above, the example NE programmer leverages one or more SDN techniques, such as OnePK APIs and/or Openflow applications, to facilitate the communication of the desired programming to the network elements and the implementation of the desired programming by the programmable network elements. In the illustrated example, the push/poll communicator 404 of FIG. 4 utilizes the interface(s) provided by the SDN technique(s) send the appropriate data (e.g., programming instructions) to the network elements. Additionally, the example push/poll communicator 400 of FIG. 4 informs the network elements of which network session to which the corresponding instructions apply. Because the network elements are to be programmed to enforce the selected network policy with respect to a particular computing device (e.g., of a particular user), the example push/poll communicator 400 of FIG. 4 provides identifying information to the network elements associated with the particular computing device and/or user for which the network policy has been selected. As described above, the example identifier 128 obtains data indicative of an identity of a user and/or computing device being used to access (or attempt to access) the enterprise network 104. The example push/poll communicator 400 of FIG. 4 provides such information (e.g., a device identifier, a network address, etc.) to the network elements, which utilize the identifying information to assign the network policy to a particular port, session, message, etc. associated with the identified computing device and/or user. Thus, the example push/poll communicator 400 of FIG. 4 provides the network elements with identification information and programming instructions such that the receiving network elements can be dynamically program one or more devices and/or applications to enforce the network policy with respect to a particular computing device. In some examples, the push/poll communicator 404 of FIG. 4 sends requests to the network elements to obtain information regarding a status (e.g., successful completion, errors present, in progress, etc.) of the programming of the corresponding network elements. In some examples, when the network session associated with the particular computing device is terminated, the network elements are programmed to enforce a default configuration with respect to subsequent users of the devices, ports, or applications.

FIG. 5 illustrates an example implementation of the example network usage visualizer 132 of FIG. 1. The example network usage visualizer 132 of FIG. 5 includes a flow data obtainer 500 that gathers information related to the interactions of the user 118 with the enterprise network 104. In the illustrated example, the example network usage visualizer 132 of FIG. 5 utilizes the SDN capabilities of the example NE programmer 130 of FIGS. 1 and/or 4 to obtain the flow information associated with network elements that have been dynamically programmed to implement the selected network policy. For instance, the example network usage visualizer 132 of FIG. 5 interfaces with the example push/poll communicator 404 of FIG. 4 to send a request to one of the programmed network elements to determine an amount of data flowing towards the example user 118 from the enterprise network 104. In some examples, the network usage visualizer 132 of FIG. 5 utilizes a data flow tracking capabilities of the network element to provide the data flow information. That is, the network element may track amounts of traffic being processed through the network element and may provide the tracked data to the example network usage visualizer 132 of FIG. 5. Further, the example network usage visualizer 132 of FIG. 5 interfaces with one or more components of the identifier 128 of FIGS. 1 and/or 3, such as the example locator 304 of FIG. 3, to obtain information related to the use of the dynamically programmed network element(s) by the user 118, such as a location from which the user 118 is accessing (or attempting to access) the enterprise network 104.

The example network usage visualizer 132 of FIG. 5 includes an administrator interface 502 to provide a user interface accessible by, for example, an administrator of the example enterprise network 104 and/or an administrator of the example NPP 102. The example administrator interface 502 of FIG. 5 presents information regarding, for example, the information gathered by the example flow data obtainer 500. For example, the administrator interface 502 of FIG. 5 facilitates display of a location from which the user 118 is accessing (or attempting to access) the enterprise network 104 via, for example, a marker on a map. Additionally or alternatively, the example administrator interface 502 of FIG. 5 presents one or more graphics representative of the amount of data flowing to the user 118 from the enterprise network 104 and/or from the user 118 to the enterprise network 104. Additionally or alternatively, the example administrator interface 502 of FIG. 5 presents one or more graphics representative of an amount of data being routed through one or more of the network elements that have been dynamically programmed to enforce the selected network policy for the user 118. In some examples, the administrator interface 502 of FIG. 5 enables the administrator to interact with one or more components of the example NPP 102 of FIG. 1 when, for example, the administrator is presented with information that causes a desire to alter one or more aspects, operations and/or settings of the dynamic network element programming disclosed herein. For example, the administrator interface 502 of FIG. 5 enables the administrator to interact with the example policy selector 306 and to instruct the policy selector 306 to re-evaluate the selection of the current network policy and/or to force the example policy selector 306 to select a certain one of the policies 202 of FIG. 2. In some examples, the administrator interface 502 of FIG. 5 enables the administrator to interact with the example policy creator 200 and/or the policies 202 to, for example, create a new network policy in response to certain network element conditions and/or to alter existing one or more of the policies 202 in response to certain network element conditions.

While an example manner of implementing the NPP 102 is illustrated in FIGS. 1-5, one or more of the elements, processes and/or devices illustrated in FIGS. 1-5 may be combined, divided, re-arranged, omitted, eliminated and/or implemented in any other way. Further, the example policy manager 126, the example policy creator 200, the example identifier 128, the example data capturer 300, the example user-IP association tracker 302, the example locator 304, the example policy selector 306, the example NE programmer 130, the example network element identifier 400, the example push/poll communicator 404, the example network usage visualizer 132, the example flow data obtainer 500, the example administrator interface 502 and/or, more generally, the example NPP 102 of FIG. 1 may be implemented by hardware, software, firmware and/or any combination of hardware, software and/or firmware. Thus, for example, any of the example policy manager 126, the example policy creator 200, the example identifier 128, the example data capturer 300, the example user-IP association tracker 302, the example locator 304, the example policy selector 306, the example NE programmer 130, the example network element identifier 400, the example push/poll communicator 404, the example network usage visualizer 132, the example flow data obtainer 500, the example administrator interface 502 and/or, more generally, the example NPP 102 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example policy manager 126, the example policy creator 200, the example identifier 128, the example data capturer 300, the example user-IP association tracker 302, the example locator 304, the example policy selector 306, the example NE programmer 130, the example network element identifier 400, the example push/poll communicator 404, the example network usage visualizer 132, the example flow data obtainer 500, the example administrator interface 502 and/or, more generally, the example NPP 102 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example NPP 102 of FIG. 1 may include one or more elements, processes and/or devices in addition to, or instead of, those illustrated in FIG. 1, and/or may include more than one of any or all of the illustrated elements, processes and devices.

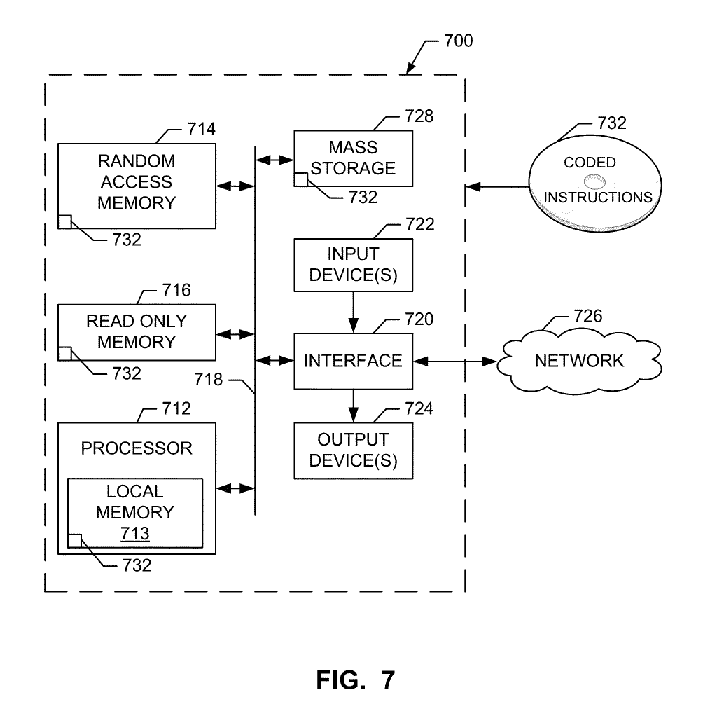

A flowchart representative of example machine readable instructions for implementing the example NPP 102 represented in FIGS. 1-5 is shown in FIGS. 6A and 6B. In this example, the machine readable instructions comprise a program for execution by a processor such as the processor 712 shown in the example processor platform 700 discussed below in connection with FIG. 7. The program may be embodied in software stored on a tangible computer readable storage medium such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIGS. 6A and 6B, many other methods of implementing the example NPP 102 of FIGS. 1-5 may alternatively be used. For example, the order of execution of the blocks may be changed, and/or some of the blocks described may be changed, eliminated, or combined.

As mentioned above, the example processes of FIGS. 6A and 6B may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 6A and 6B may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

The program of FIGS. 6A and 6B begins with an entity, such as a company associated with the example enterprise network, subscribing to services provided by the example NPP 102 of FIG. 1 (block 600). In the illustrated example, at least one instance of the NPP 102 is provided for each subscribing entity and/or each enterprise network. The instances of the example NPP 102 are hosted by, for example, server(s) operated by a provider of the NPP 102 such as, for example, AT&T® and/or any other internet service provider.

The example policy manager 200 of FIG. 2 provides an interface to facilitate creation of one or more network policies by, for example, the entity associated with the enterprise network 104 (block 602). For example, the policy manager 200 of FIG. 2 presents options and/or data entry fields to receive information to define particular aspect(s) of the network policies, such as data flow restrictions and/or guarantees, application restrictions, prioritization information, etc. Further, the example policy manager 200 presents options and/or data entry fields to receive information indicative of circumstances for which each network policy is to be selected for enforcement. Example circumstances include a particular user accessing the enterprise network 104, a location from which the enterprise network 104 is being accessed, an identity of a computing device being used to access the enterprise network 104, and a type of computing device being used to access the enterprise network 104. The example policy creator 200 of FIG. 2 uses the received information to generate the network policies and to designate the individual network policies for use in the corresponding circumstances (block 604). The example policy manager 126 stores the generated network policies 202, which are accessible to, for example, other components of the NPP 102 (block 606).

In the example of FIG. 6, the NPP 102 of FIG. 1 determines whether the enterprise network 104 has been accessed (block 608). If not, the example NPP 102 continues to determine whether the enterprise network 104 has been accessed. If an access is detected (block 608), the example data capturer 300 of FIG. 3 obtains information related to the circumstances of the detected access of the enterprise network 104 (block 610). For example, the data capturer 300 determines an identity of the user 118 that has accessed the enterprise network 104, an identity of the computing device (e.g., the first, second or third computing devices 120-124 of FIG. 1) being used to access the enterprise network 104, and/or a type of computing device being used to access the enterprise network 104. Additionally, the example locator 304 of FIG. 3 obtains information related location based circumstances of the detected access such as, for example, a geographic location associated with the detected access (block 610). Further, the example user-IP association tracker 302 of FIG. 3 identifies a network address associated with the access of the enterprise network 104 and tracks the identified network address for the network session initiated by the user 118 (block 612).

In the example of FIG. 6, the policy selector 306 of FIG. 3 uses the obtained information related to the circumstances in which the enterprise network 104 has been accessed to select one of the network policies 202 of FIG. 2 (block 614). As described above, this selection of a network policy occurs dynamically in response to the particular detected access of the enterprise network 104. In the illustrated example, the selected network policy for the detected circumstances surrounding the detected access is provided to the example NE programmer 130 of FIGS. 1 and/or 4. The example NE identifier 400 of the example NE programmer 130 determines which network elements (e.g., the example router 114, the example switch 116, and/or a combination thereof) are to be dynamically programmed with the selected network policy (block 616). In particular, the example NE identifier 400 of FIG. 4 identifies network elements that are facilitating communication between the user 118 and the enterprise network 104, determines which of the identified network elements are dynamically programmable (e.g., are SDN-enabled), and/or determines which of the identified network elements the example NE programmer 130 is able to dynamically program.

When the example NE identifier 400 determines which network element(s) are to be dynamically programmed (block 616), the example push/poll communicator 404 of FIG. 4 conveys programming instructions to those network element(s) to enable the network element(s) to be programmed according to the selected network policy (block 618). As described above, this programming of the network element(s) occurs dynamically in response to the detected access of the enterprise network 104. In the illustrated example, the push/poll communicator 404 of FIG. 4 confirms whether the network element(s) were successfully (e.g., without error) programmed to implement the selected network policy when facilitating communications involving the identified particular user (block 620). In the example of FIG. 6, the programming instructions are re-conveyed to the network element(s) if the programming was unsuccessful (block 618).

When the network element(s) have been successfully programmed (block 620), the example flow data obtainer 500 of FIG. 5 collects information related to usage of, for example, the dynamically programmed network element(s) (block 622). The obtained information includes usage data associated with the identified user 118 and/or overall usage data associated with the network element(s). The example administrator interface 502 of FIG. 5 presents the obtained usage information to, for example, an administrator of the enterprise network 104 and/or an administrator of the example NPP 102 (block 626). As described above, the administrator interface 502 enables interaction with, for example, the NPP 112 based on the presented information. If a network session corresponding to the detected access of the enterprise network 104 has ended (e.g., if the user 118 has disconnected from the enterprise network 104) (block 626), control returns to FIG. 6A. Otherwise, control returns to block 622.

FIG. 7 is a block diagram of an example processor platform 700 capable of executing the instructions of FIGS. 6A and 6B to implement the example NPP 102 of FIGS. 1-5. The processor platform 700 can be, for example, a server, a personal computer, an Internet appliance, or any other type of computing device.

The processor platform 700 of the illustrated example includes a processor 712. The processor 712 of the illustrated example is hardware. For example, the processor 712 can be implemented by one or more integrated circuits, logic circuits, microprocessors or controllers from any desired family or manufacturer.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) can be implemented by, for example, a microphone, a keyboard, a button, a mouse, a touchscreen, a track-pad, a trackball, isopoint and/or a voice recognition system.

One or more output devices 724 are also connected to the interface circuit 720 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes one or more mass storage devices 728 for storing software and/or data. Examples of such mass storage devices 728 include floppy disk drives, hard drive disks, compact disk drives, Blu-ray disk drives, RAID systems, and digital versatile disk (DVD) drives.

The coded instructions 732 of FIGS. 6A and 6B may be stored in the mass storage device 728, in the volatile memory 714, in the non-volatile memory 716, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
determining a context associated with an attempt to access, by a user via a computing device, a network;
selecting, via a processor, a network policy based on the context; and
programming, in response to the attempt to access the network, a dynamically programmable network element to enforce the network policy.

2. The method of claim 1, further comprising selecting the dynamically programmable network element to be programmed to enforce the network policy if the dynamically programmable network element is to facilitate communication between the network and the computing device.

3. The method of claim 1, wherein programming the dynamically programmable network element comprises sending programming instructions to the dynamically programmable network element.

4. The method of claim 1, wherein the context is defined by an identity of the user and the network policy is selected based on the identity.

5. The method of claim 1, wherein the context comprises a location from which the user attempts to access the network, and the network policy is selected based on the location.

6. The method of claim 1, wherein the context comprises a type of the computing device, and the network policy is selected based on the type of the computing device used to attempt to access the network.

7. The method of claim 1, wherein the context comprises a combination of a location from which the network is being accessed and an identity of the user.

8. The method of claim 1, wherein the context comprises an identity of a network resource being accessed, and the network policy is selected based on the identity of the network resource.

9. A tangible computer readable storage medium comprising instructions that, when executed cause a machine to perform operations comprising:
determining a context associated with an attempt to access, by a user via a computing device, a network;
selecting a network policy based on the determined context; and
programming, in response to the attempt to access the network, a dynamically programmable network element to enforce the network policy.

10. The tangible computer readable storage medium of claim 9, wherein the operations further comprise selecting the dynamically programmable network element to be programmed to enforce the network policy if the dynamically programmable network element is to facilitate communication between the network and the computing device.

11. The tangible computer readable storage medium of claim 9, wherein programming the dynamically programmable network element comprises sending programming instructions to the dynamically programmable network element.

12. The tangible computer readable storage medium claim 9, wherein the context is defined by an identity of the user and the network policy is selected based on the identity.

13. The tangible computer readable storage medium of claim 9, wherein the context comprises a location from which the user attempts to access the network, and the network policy is selected based on the location.

14. The tangible computer readable storage medium of claim 9, wherein the context comprises a type of the computing device, and the network policy is selected based on the type of computing device used to attempt to access the network.

15. The tangible computer readable storage medium of claim 9, wherein the context comprises a combination of a location from which the network is being accessed and an identity of the user.

16. The tangible computer readable storage medium of claim 9, wherein the context comprises an identity of a network resource being accessed, and the network policy is selected based on the identity of the network resource.

17. An apparatus, comprising:
memory comprising machine readable instructions; and
a processor to execute the instructions to perform operations comprising:
determining a context associated with an attempt to access, by a user via a computing device, a network;
selecting a network policy based on the determined context; and
programming, in response to the attempt to access the network, a dynamically programmable network element to enforce the network policy.

18. The apparatus of claim 17, the operations further comprising selecting the dynamically programmable network element to be programmed to enforce the network policy if the dynamically programmable network element is to facilitate communication between the network and the computing device.

19. The apparatus of claim 17, wherein programming the dynamically programmable network element comprises sending programming instructions to the dynamically programmable network element.

20. The apparatus of claim 17, wherein the context comprises a combination of a location from which the network is being accessed and an identity of the user.
